(19) United States
(12) Patent Application Publication
(10) Pub. No.: US 2005/0156023 A1
(43) Pub. Date: Jul. 21, 2005

(54) Apparatus and method for data collection, tracking and distribution system using an image tag

(75) Inventor: James Yuran, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: Ego Id, Inc.

(21) Appl. No.: 11/041,138

(22) Filed: Jan. 20, 2005

Related U.S. Application Data
(60) Provisional application No. 60/537,845, filed on Jan. 21, 2004.

(51) Int. Cl. G06F 17/00

(52) U.S. Cl. 235/375; 340/572.1; 340/5.92

(57) ABSTRACT

A data collection, tracking and distribution system using an image tag includes a host computer system connected to a user data input terminal via a global computer network, a vendor computer and a retailer computer that can capture, track, and disseminate user and card data via a data exchange bus between the host computer, vendor computer, and retailer computer. The vendor computer includes a card data storage device and a scanner for scanning an image tag. Collections of image tags may have similar data fields, and the information within those data fields may be disseminated to vendors, retailers, and the host computer system. The image tag is formed to have an aesthetically pleasing external shape with an image on the front of the tag, and an image tag identifier on the back of the tag.

### RELATED APPLICATIONS

This application claims the benefit of priority to U.S. Provisional Patent Application Ser. No. 60/537,845, filed Jan. 21, 2004, entitled “Apparatus and method for data collection, tracking and distribution system using an image tag”, and currently co-pending.

### FIELD OF THE INVENTION

The present invention relates generally to the collection of data for use in consumer-based marketing and promotional activities. The present invention is more particularly suited for the collection of data regarding customer activities, tracking the activities of that customer, and for distributing the customer data. The present invention is more particularly, though not exclusively, useful as a data exchange system in which the data collection, tracking and distribution is facilitated with the use of an image tag bearing a unique tag identifier.

### BACKGROUND OF THE INVENTION

Over the years, efforts to promote and advertise a business and its products or services have become increasingly challenging. The challenge, in large part, is due to the continual need for the innovation of unique, appealing and customer-accepted promotions. Traditionally, advertising was in print form, radio advertising, or television spots. While these traditional approaches to advertising were somewhat effective, they were primarily one-sided in that there was no direct connection between the advertiser and the possible end user. The advertisements were launched into the marketplace, and the end user either responded or not.

An improvement in the advertising approach was the introduction of direct market mailing. This approach provided a more focused advertising and promotion audience identified by region and particular demographics (home owners, for example). However, this type of advertisement and promotion still required the potential end user to affirmatively respond to the advertisement materials.

An additional shortcoming with currently used advertising and promotional programs is the ordinary style of the promotional materials themselves. In short, regardless of the fancifulness and artistic qualities in typical print, radio and television advertising, the advertising materials have no other characteristic that an end user would seek out.

In light of the above, it would be advantageous to supplement or replace the currently available promotional and advertisement materials with a system which is generally sought out by consumers. It would be also advantageous to provide a promotional system that entices and includes active participation by the end users. It would also be advantageous to provide a promotional system that facilitates the vendor's gathering of information regarding the end users, as well as provide an avenue for the future dissemination of advertising and promotional materials targeting specific end users.

### SUMMARY OF THE INVENTION

The “Ego Id Tag” of the present invention incorporates a web based demographic data acquisition/sharing system having a database designed to combine the unique wearable fashion accessory function and popularity of the patented Ego Id “Image Tag”. The “Ego Id Tag” is composed of an “Image Tag” with the addition of a unique identifier to each tag. The identifier can be a laser engraved serial number, bar code, ID matrix, embedded RF tag or the like.

The “Ego Id Tag” becomes an end user's wearable fashion identification card that is part of a demographic data tracking protocol implemented for promotions or admissions across a wide variety of markets, vendors, or retailers. The “Ego Id Tag” is worn or carried by the end user and can be read by conventional “scanning” terminals at designated locations.

“Ego Id Tags” are issued by vendors or retailers to end users, and the tags may be used anonymously or require activation by the end user via the web prior to use. Activation may require the end user to enter personal information or data. Once an “Ego Id Tag” is acquired and/or activated by an end user, a wide variety of rewards or benefits can be created as part of a promotion and only obtained by “scanning” the “Ego Id Tag” at designated locations. All rewards can be contingent upon specific requirements imposed on the end user by the vendor or retailer, and thus encoded within the database rule structure, in order to use the “Ego Id Tag” for its intended purpose.

Once a “scan” has taken place, the “Ego Id Tag” information is instantly relayed to the Host computer database and then back to the person at the terminal alerting him or her to any pre-assigned circumstance associated with the specific “Ego Id Tag”. The “Ego Id Tag” may entitle the end user to a certain prize or discount, grant or deny access, register as valid/invalid, or display any other unique promotion or specific data the end user, vendor or retailer has made available to the database. The database can be continuously modified by the vendor or retailer to reflect new promotions, new prizes, or new events for which an existing batch of “Ego Id Tags” can be used.

The flexibility of the database allows each unique “Ego Id Tag” to have a unique circumstance assigned to it and that circumstance to be changed at will. Rules created in the database my require users to perform certain tasks before being rewarded. A vendor can share the information with retail partners or use the information within the database to drive and target future sales, correlate marketing effectiveness, reward its customers for some specific activity, track user tasks, etc.

### BRIEF DESCRIPTION OF THE DRAWING

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a block diagram of the data collection, tracking and distribution system using an image tag showing a host computer system connected to a user data input terminal via a global computer network, a vendor computer and a retailer computer that can capture, track, and disseminate user and card data via a data exchange bus between the host computer, vendor computer, and retailer computer;

FIG. 2 is a block diagram of a vendor computer having a card data storage device and showing a scanner scanning a representative image tag, along with an exemplary collection of data fields related to a specific image tag, or collection of image tags, such as a collection of tags distributed at a single event, or by a single vendor;

FIG. 3 is a diagram representation of a first collection of image tags having a first category data field, and a second collection of image tags having a different category data field;

FIG. 4 is a block diagram of an exemplary operation of the data collection, tracking and distribution system of the present invention showing the distribution of the image tags, the collection of information regarding the image tags, and the dissemination of that information to vendors, retailers, and the host computer system;

FIG. 5 is a front and back view of an exemplary image tag having a user-appealing shape, construction and image on the front, and an image tag identifier, such as a bar code, on the back, and also showing (in dashed lines) an electronic identifier, such as a radio frequency (RF) identifier;

FIG. 6 is an alternative embodiment of an image tag having a different external shape than the image tag of FIG. 5, and having an image on the front of the tag, an image tag identifier on the back; and

FIG. 7 is a table showing exemplary user and card data fields that may be contained in the memory of the present invention and which may be associated with one or more image tag identifiers.

### DETAILED DESCRIPTION

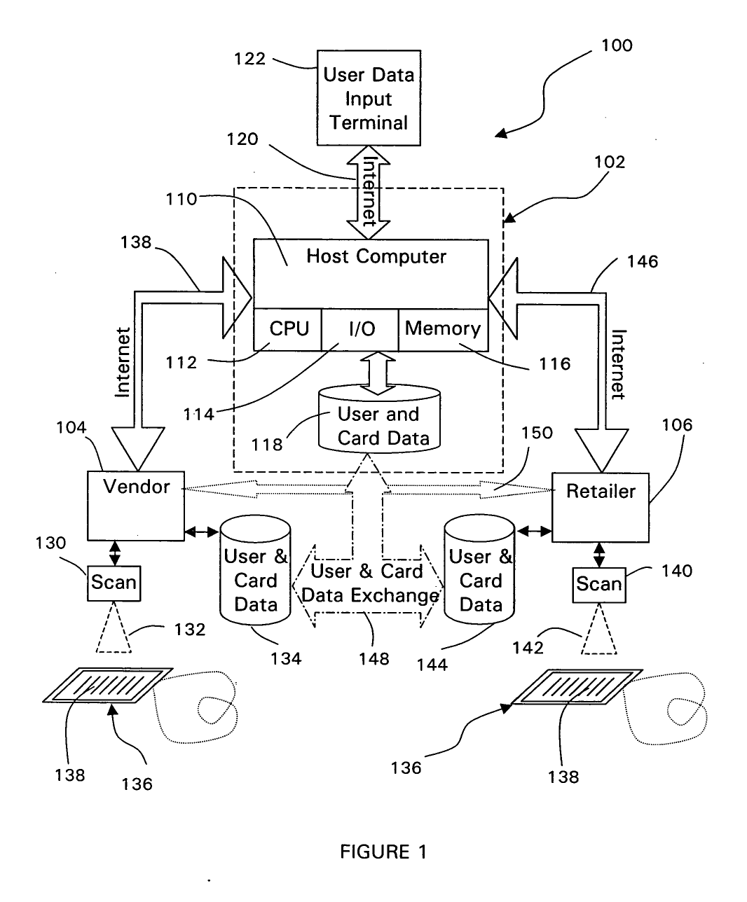

Referring now to FIG. 1, a block diagram of the data collection, tracking and distribution system using an image tag of the present invention is shown and generally designated 100. System 100 includes a server 102, a vendor computer 104, and a retailer computer 106.

Server 102 is equipped with a host computer 110 having a central processing unit (CPU) 112, such as a microprocessor, reduced instruction set computer (RISC), or microcontroller. An input/output device 114, such as a monitor and keyboard, provide for the entering of data, and program algorithms to the central processing unit 112. A memory device or devices 116 is provided to maintain both permanent memory and transient memory for CPU 112. Permanent memory may be in the form of read only memory (ROM), and transient memory may be in the form of random access memory (RAM). It is to be appreciated, however, that despite the specification of ROM and RAM, such examples are merely exemplary of a preferred embodiment, and that no limitation as to the memory is intended.

Memory device 118 is provided to store user and card data for the server 102. This memory device 118 is a permanent memory storage device, and may be magnetic disc memory, optical disc memory, semiconductor ROM, or other memory technologies known in the art.

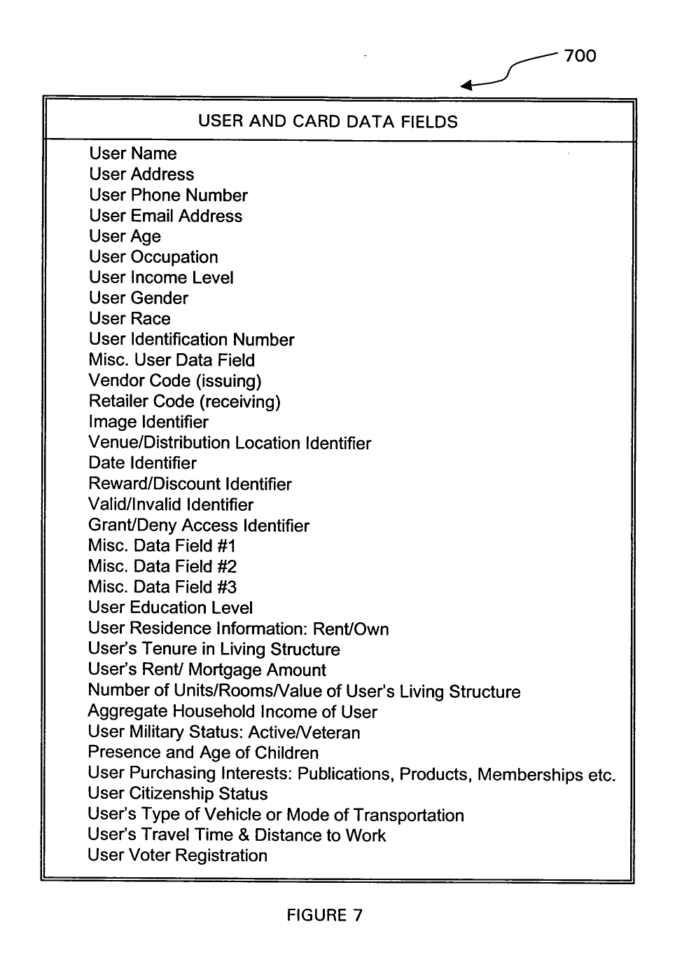

An example of the user and card data utilized in a preferred embodiment of the data collection, tracking and distribution system using an image tag of the present invention, as will be discussed in greater detail below, are shown in FIG. 7. It is to be appreciated, however that the listing of data fields is merely exemplary and not intended as a limitation as to the number, type, or contents of memory device 118.

Server 102 is in communication with a global computer network 120, such as the Internet. One or more user data input terminal s 122 may be interconnected to the server 102 via the global computer network 120 to facilitate a user's addition of user and/or card data to host computer 110 and memory storage 118.

Vendor computer 104 is equipped with a scanning device 130, such as an optical or radio frequency (RF) transmitter and receiver. The scanner 130 has a scanning field 132 for sensing an image tag 136 and receiving an image tag identifier 138, such as an optical bar code or a RF signature. Once this image tag identifier 138 is received by scanner 130, the image tag identifier 138 may be recorded in user and card data storage device 134. This user and card data may include one or more of the data fields listed in FIG. 7, or additional data fields as the vendor determines.

Retailer computer 106 is equipped with a scanning device 140, of a similar or different type than scanning device 130, and having a scanning field 142 for sensing an image tag 136 and receiving an image tag identifier 138. Once this image tag identifier 138 is received by scanner 140, the image tag identifier 138 may be recorded in user and card data storage device 144. This user and card data may include one or more of the data field listed in FIG. 7, or additional data fields as the retailer determines.

It is important to note that the data stored in the user and card data storage 134 may be equivalent to the data stored in the user and card data storage 144. On the other hand, the data may vary depending on the desires or requirements of the vendor or retailer. Also, user and card data storage 118 of the server 102, user and card data storage 134 and user and card data storage 144 are all interconnected to a user and card data exchange bus 148. In a preferred embodiment, data exchange bus 148 may be a global computer network, such as the Internet, or it may be any other network for exchanging information known in the art.

In addition to or alternatively to the data exchange bus 148, a communication channel 150 may be provided between the vendor computer 104 and the retailer computer 106. This channel 150 provides for the direct exchange of data between the vendor computer 104 and retailer computer 106 without sharing such exchanged information with the server 102. This communication channel may be through any communication means known in the art.

Vendor computer 104 and retailer computer 106 may be connected to host computer 110 of server 102 through a global computer network 138 and 146 respectively, such as the Internet. This connection provides for the direct exchange of information between the vendor computer 104 and host computer 110, and between retailer computer 106 and host computer 110.

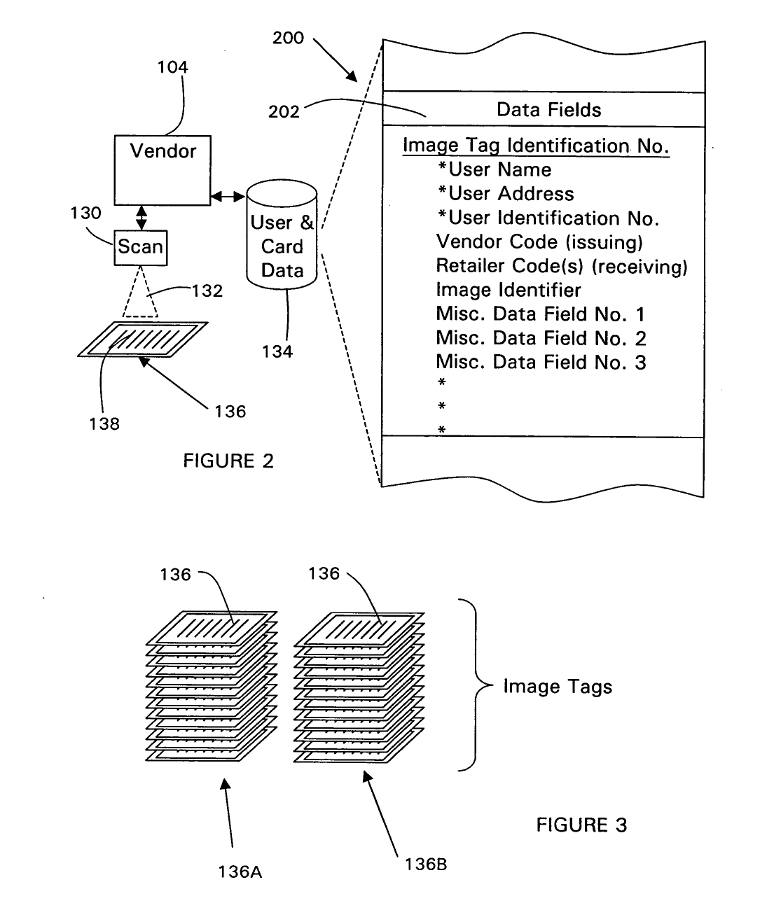

Referring now to FIG. 2, a block diagram of a vendor computer 104 is shown having user and card data storage device 134, and a scanner 130 having a scanning field 132 through which a representative image tag 136 is passed so that the image tag identifier 138 is sensed by scanner 130. Once scanned, the image tag identifier 138 provides a pointer to a data record 200 containing data fields 202. Each data field 202 corresponds to an image tag identifier 138, such as an image tag identification number, and contains information regarding the particular image tag 136. In some circumstances, an image tag identifier 138 may identify a specific image tag, or collection of image tags, such as a collection of tags distributed at a single event, or by a single vendor.

FIG. 3 contains a diagrammatic representation of a first collection 136A of image tags 136 having a first common data field, and a second collection 136B of image tags 136 having a different common data field. For instance, collection 136A may all have a common image identifier data field, and collection 136B may all have a common vendor code data field. The image identifiers 138 for each of these image tags 136 may be predetermined to have a common data field prior to the dissemination of each of the image tags 136.

### Operation of the Data Collection, Tracking and Distribution System Using an Image Tag of the Present Invention

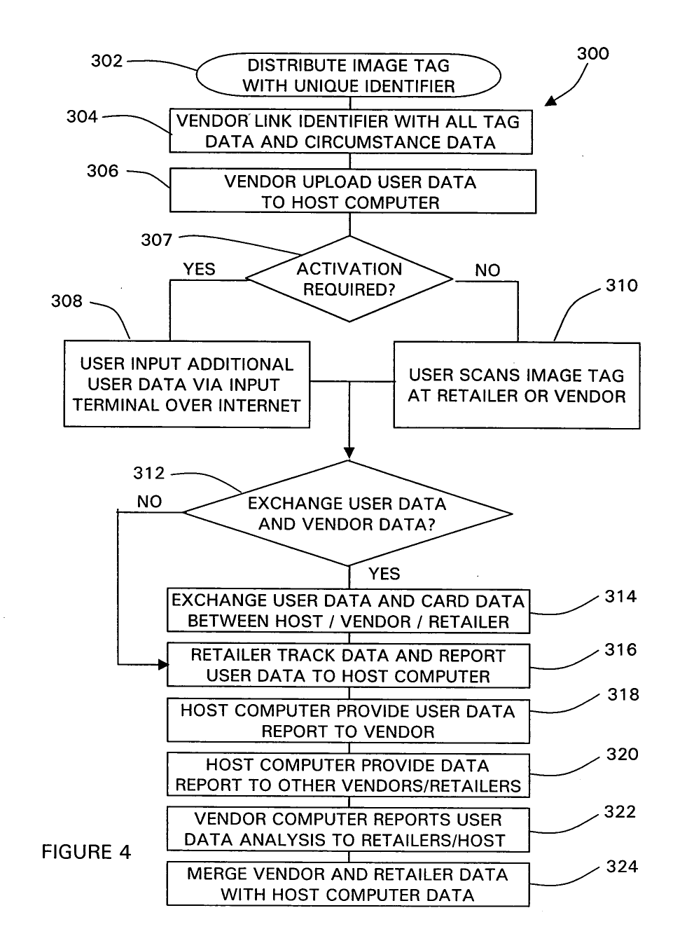

Referring to FIG. 4, a block diagram of an exemplary operation of the data collection, tracking and distribution system of the present invention is shown as method 300. Method 300 begins with step 302 in which an image tag, containing a unique image tag identifier, is distributed.

A vendor may link the particular image tag identifiers with all of a collection of tags' data and circumstance data, in step 304. For instance, a vendor may link a collection of image tag identifiers together as those image tags that were passed out at a particular event, such as a baseball “opening day.” While the event-specific data field will identify all of the “opening day” tags, each tag will have other data fields which will identify characteristics unique to the recipient of the tag, such as name, address, date, ballpark name, etc.

The addition of unique information into data fields associated with a particular image tag can be accomplished in step 306 wherein a vendor may upload user data to the host computer within the server. For instance, the vendor may upload the “opening day” data field to the host computer to link the group of image tag identifiers as those image tags given away at that event.

In some circumstances, the image tag must be activated. This is determined in step 307. For example, a vendor may require that a user “activate” the image tag in step 308 by providing additional data via the user data input terminal. For instance, in order to claim a benefit of the image tag, such as showing the tag to receive a sponsoring baseball cap, the user may be required to provide additional information such as his name, address, E-mail address, personal preferences, etc. Alternatively, if an image tag given away on the opening day grants the user a ten-percent (10%) discount at a local grocery store, the image tag may be scanned at a retailer or vendor in step 310 without the need for “activating” the tag.

Once the image tag has been activated or scanned, the system of the present invention has the option to exchange the user data and vendor data between the vendor computer, the retailer computer, and the host computer in step 312. If the information is to be exchanged, the user data and card data are exchanged between the host computer, vendor computer, and retailer computer in step 314.

On the other hand, if no data is to be exchanged, the retailer computer tracks the user data and the card data and may report the data to the host computer in step 316. If desired, the host computer may provide the user data to the vendor computer in step 318. It is important to realize that the data exchanges discussed herein are intended to represent the exchange of some or all of the data represented in the data fields in the data record. There is no specific requirement what data fields must be exchanged, and the user may limit the information exchange through the entry of a privacy field signifying his desire that no personal information be exchanged. Similarly, other data fields, such as address, phone, sex, and/or preferences may be withheld from the exchange process. Also, it is important to realize that the system of the present invention may facilitate the dissemination of all data fields to vendors, retailers, and the host computer system.

In step 320, the host computer may provide data reports to the vendor computer and the retailer computer. This may be done on a periodic basis, such as quarterly, to integrate the information that the host computer has collected from the vendor computer and the retailer computer(s). For example, a quarterly report could be provided by the host computer summarizing the number of image tag recipients from “opening day” that have redeemed their image tag to take advantage of a discount at a retailer. This information could have been collected from several retailers over the course of a quarter, and the information could be exchanged with the vendor, such as the baseball team, at the end of the quarter. This would provide a significant collection of image tag user information that could serve to increase, decrease, or adjust, the team's marketing efforts.

In some circumstances, it would be useful for the vendor computer to report user data to the retailer computer(s) and the host computer. For instance, in step 322, a vendor computer may provide a report of the number of users of image tags have identified through the user's input of information, how they perceive the retailer(s) services, or provide additional comments regarding data collected through the user's use of the image tags with other retailers.

Step 324 provides for the merging of vendor data and retailer data within the host computer. The results of this information merge, such as image tag usage reports, may be provided to the various vendors and retailers. This information may be used to increase, decrease, adjust, or discontinue any joint advertising or promotional programs that may exist between the vendors and retailers. For instance, in the event none of the “opening day” image tags were presented at a particular retailer, it may be advantageous for the vendor to redirect its marketing efforts to another retailer at which seventy five percent (75%) of the “opening day” image tags were presented.

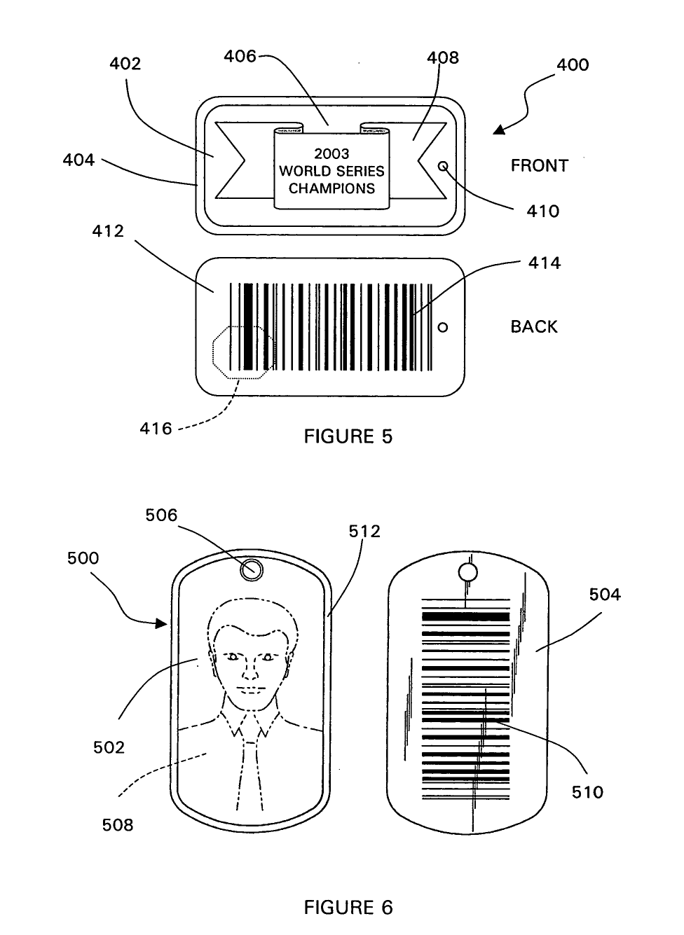

Referring now to FIG. 5, a front and back view of an exemplary image tag is shown and generally designated 400. Image tag 400 includes a body 402 having a rolled edge 404 that retains an image panel 406 having an image 408 on the front of the tag 400. A hole 410 may be formed to allow the image tag 400 to receive a chain, such as for wearing around the user's neck. The backside 412 of the tag 400 is equipped with an image tag identifier 414 shown in the form of an optical bar code. It is to be appreciated, however, that the optical bar code 414 as shown is merely exemplary of a preferred embodiment, and that other optical image tag identifiers may be used, such as alpha-numeric characters, symbols or the like. Also, image tag 400 may be equipped with an RF image tag identifier 416 (shown in dashed lines). RF image tag identifier 416 may be selected from any one of the radio frequency responding devices known in the art, including a passive radio frequency reflecting antenna, and an active radio frequency signal generator, for example.

Referring to FIG. 6, an alternative embodiment of an image tag of the present invention is shown and generally designated 500. Image tag 500 has a different external shape than the image tag 400 of FIG. 5. Image tag 500 includes an image 508 (shown in dashed lines) on the front 502 of the tag 500, and an image tag identifier 510 on the back 504. This particular image tag of the present invention is formed with a rolled edge 512, and has a particularly desirable ornamental appearance, protected by the U.S. Design Pat. No. DES476,693 issued to the inventor of the present invention.

It is to be appreciated that while the present invention enjoys commercial acceptance due in large part to the appealing ornamental appearance of a particular image tag shape, the present invention is not limited by the shape of the image tag. On the contrary, the present invention is not limited to any particular shape, design, or material of manufacture.

Referring to FIG. 7, a table showing an exemplary selection user and card data fields is generally designated 700. Table 700 is merely exemplary of data fields that may be associated with user data fields and card data fields for an image tag. The fields that are identified are not exclusive, nor is the list of fields comprehensive. Rather, it is important to realize that the number, length, and types of data fields may vary depending on the available memory, the desire of the vendor and/or retailers, and may change from time to time depending on the needs of the server, vendor and retailer.

Example of Use and Operation of a Preferred Embodiment

A specific example of how an image tag of the present invention (the “Ego Id Tag”) can be used is as follows:

At a Major League Baseball sporting event, 50,000 image tags from a vendor named Ego Id, Inc., (“Ego Id Tags”) (with team logos and players) are given out to all adoring fans entering the event as an accessory to wear and show team spirit. During the 7^{th} inning raffle, one lucky “Ego Id Tag” wearer (the “user”) is selected as the winner of a new Ford™ truck. The remaining “Ego Id Tag” wearers are then instructed to go to their local Ford™ dealers to scan their “Ego Id Tags” to claim a prize or even receive a substantial discount on the purchase of a new automobile within a given time frame. In addition, a popular coffee shop retailer, such as Starbucks™ is also a sponsor offering one free small beverage to every “Ego Id Tag” wearer within the following two (2) weeks.

The fashionable “Ego Id Tag” (with the fan's favorite player) can also be transformed into a Starbucks™ Club Card, by activating the tag via the web by the user by uploading his or her personal information. The user now scans the “Ego Id Tag” every time they shop at Starbucks™ and accumulates points toward free products. In this example, the information gathered from the scanning of the Ego Id Tag image tag at the various retailers can show exactly how many people went to Ford™ and Starbucks™ as a result of attending a baseball game. The information can be shared to determine what percentage of new car buyers also drink Starbuck's™ coffee, etc.

While the data collection, tracking and distribution system using an image tag of the present invention as herein shown and disclosed in detail is fully capable of obtaining the objects and providing the advantages herein before stated, it is to be understood that it is merely illustrative of the presently preferred embodiments of the invention and that no limitations are intended to the details of operation, implementation, construction or design herein shown other than as described in the appended claims.

1. A method for data collection, tracking and distribution using an image tag, comprising the steps of:
providing an image tag having at least one image tag identifier;
linking the image tag identifiers with card data and circumstance data;
activating the image tag;
obtaining card data and circumstance data associated with the image tag identifier at a vendor site;
developing vendor data; and
exchanging the card data, circumstance data and vendor data obtained at the vendor site with a host computer.

2. The method of claim 1, further comprising exchanging user data and vendor data with a retailer computer.

3. The method of claim 1, further comprising exchanging user data and vendor data with vendor computer.

4. The method of claim 1, further comprising exchanging data between a host computer, a vendor computer and a retailer computer.

5. The method of claim 1, further comprising tracking the user data and card data at the vendor computer.

6. The method of claim 5, further comprising exchanging the user data and card data between the vendor computer and the host computer.

7. The method of claim 5, further comprising exchanging the user data and card data between the vendor computer and another vendor computer.

8. The method of claim 1, further comprising:
tracking the user data and the card data; and
reporting the user data and the card data to the host computer.

9. The method of claim 1, wherein exchanging data includes exchanging data from one or more data fields selected from the set of data fields including address, phone, sex, and preferences.

10. The method of claim 1, further comprising:
providing data reports to the vendor computer and the retailer computer.

11. The method of claim 1, further comprising:
reporting user data from the vendor computer to a retailer computer.

12. The method of claim 11, further comprising:
reporting card data from the vendor computer to a retailer computer.

13. The method of claim 1, further comprising:
merging vendor data and retailer data within the host computer to create a merged database.

14. The method of claim 13, further comprising:
reporting at least a portion of the merged database between the host computer and at least one retailer.

15. The method of claim 13, further comprising:
reporting at least a portion of the merged database between the host computer and at least one vendor.

16. A system for data collection, tracking and distribution, comprising:
an image tag having an image tag identifier;
a host computer having a memory capable of storing and retrieving data corresponding to the image tag identifier;
a vendor computer having a scanning device capable of reading the image tag identifier, the vendor computer in communication with the host computer;
a retailer computer having a scanning device capable of reading the image tag identifier, the retailer computer in communication with the host computer; and
a means for exchanging data between the host computer and the vendor computer, and between the host computer and the retailer computer.

17. The system of claim 16, wherein the means for exchanging data between the host computer and the vendor computer further comprises a communication channel between the host computer and the vendor computer.

18. The system of claim 16, wherein the means for exchanging data between the host computer and the retailer computer further comprises a communication channel between the host computer and the retailer computer.

19. The system of claim 16, further comprising a means for exchanging data between the vendor computer and one or more retailer computers.

20. The system of claim 16, wherein the image tag identifier is an optical bar code identifier.
